(19) United States
(12) Patent Application Publication
(10) Pub. No.: US 2012/0206730 A1
(43) Pub. Date: Aug. 16, 2012

(54) INTERFEROMETER

(76) Inventor: Tatsutoshi Shioda, Nagaoka-shi (JP)

(21) Appl. No.: 13/262,389

(22) PCT Filed: Mar. 30, 2010
(86) PCT No.: PCT/JP2010/055771

§ 371 Date: Apr. 27, 2012

(30) Foreign Application Priority Data
Mar. 30, 2009 (JP) 2009-080747

(51) Int. Cl. G01B 9/02

(52) U.S. Cl. 356/450

(57) ABSTRACT

The light from the light source of the wideband light is reflected by VIPA so that reflection distance varies step by step. In VIPA, the light that phase changed is generated depending on the depth of the step. A interference profile is measured by this reflected light and optical path length modulator by synthetic light with the generated optical frequency comb. The interferometer does not have a movable scanning mechanism, and the operation of the Fourier transform is unnecessary. Thus, it has the measurement of the short time. The measurement of the coaxial tomography and the one-dimensional coaxial tomography of the depth direction is possible. The measurement of the two-dimensional coaxial tomography of the depth direction is possible.

### FIELD OF THE INVENTION

The present invention relates to an interferometer which it is suitable for a profile measurement, and it does not have a movable scanning mechanism and does not calculate Fourier transforms. More particularly, the present invention relates to an interferometer which can measure a one-dimensional coaxial tomography of a depth direction or a two-dimensional coaxial tomography of a depth direction using a light source of wideband light (white light, super continuum light, etc.) and an optical path length modulator (a spectroscope for generating an optical frequency comb may be provided in before or after the optical path length modulator), wherein the optical path length modulator can generate a modulated light which light path length changed into depending on a one-dimensional position on a cross section that is perpendicular to a spread direction.

### BACKGROUND ART

For example, a distance measuring device (an interferometer) of Michelson type is used to measure a surface shape of an object. or an internal structure of a light transmission object (compare non-patent document 1). As the distance measuring device of Michelson type, a device using a white light source is known as shown in FIG. 12. In the distance measuring device 91 of FIG. 12, a white light WL from a white light source 911 transmits a beam splitter 912. The white light WL is emitted for a measuring object 913. On the other hand, the white light WL from the white light source 911 is reflected by a beam splitter 912. The white light WL which reflected is emitted for a movable mirror 914.

The reflected light LR1 of the measuring object 913 is reflected by the beam splitter 912, and the reflected light LR2 of the movable mirror 914 transmits the beam splitter 912. Two reflected lights LR1 and LR2 are synthesized. The synthetic light LR3 is entered to an interference profile measuring instrument 915. The interference profile measuring instrument 915 measures an interference profile of the white light.

In FIG. 12, a scanning mechanism 917 moves the movable mirror 914 (the scanning mechanism 917 scans distance). When a distance from the measuring object 913 to the interference profile measuring instrument 915 and a distance from the movable mirror 914 to the interference profile measuring instrument 915 are equal, interference produces. This interference depends on the inverse Fourier transform of the power spectrum of the white light WL that is emitted from the white light source 911 shown in FIG. 13 (A).

As shown in FIG. 13 (B), a width of the interference wave form is inversely proportional to a bandwidth (Δω in FIG. 13 (B)) of the white light source 911. Thus, a resolving power rises when the white light source 911 is used. The synthesized light LR3 is an autocorrelation function of the white light source 911 which assumed the scanning distance (ΔL) of the movable mirror 914 a variable. 2π/Δω is half-band width of an autocorrelation functions in FIG. 13 (B).

A distance measuring device using an optical frequency comb source 921 is known as shown in FIG. 14, too. In the distance measuring device 92 of FIG. 14, a fixed mirror 924 is used replacing with a movable mirror 914 of FIG. 12. In the distance measuring device 92 of FIG. 14, an interference profile measuring instrument 925 is used replacing with the interference profile measuring instrument 915 for the white light. The interference profile measuring instrument 925 measures an interference profile of the optical frequency comb. The beam splitter 922 is the same as a beam splitter 912 of FIG. 12. The propagation optical path of the optical frequency comb CMB that the optical frequency comb source 921 emits is the same as propagation optical path length in FIG. 12. In FIG. 14, optical frequency comb from the measuring object 923 which reflected is shown as CMB_R1. A reflected optical frequency comb from the fixed mirror 924 is shown as CMB_R2, and a synthesized light of between the optical frequency comb and the reflected optical frequency comb is shown as CMB_R3.

In the fixed mirror 924 of the distance measuring device 92, scanning by a distance is not carried out. However, on the other hand, the optical frequency comb CMB shown in FIG. 15 (A) is scanned by a comb teeth interval ΔQ.

The interference profile measuring instrument 925 can measure interference profiles to occur then in the resolving power that responded to number of teeth of comb. As shown in FIG. 15 (B), the width of the interference wave form is inversely proportional to a bandwidth (2π/Δτ in FIG. 15 (B)) of the optical frequency comb CMB. Δτ is half-band width of the autocorrelation function.

### PRIOR ART DOCUMENTS

### Non-Patent Document

[Non-Patent Document 1]
Op. Ltt. 25 (2) 111 (the detached room measuring device using the white light source)

### SUMMARY OF THE INVENTION

### Problem to be Solved by the Invention

In the distance measuring device 91 shown in FIG. 12, high resolving power can be obtained to use white light. However, long time is needed for measurement because of scanning by the movable mirror 914. A size of the distance measuring device becomes bigger because of a size of movable mechanism. Even more particularly, in distance measuring device 92 shown in FIG. 12, mechanical maintenance is necessary, and production cost becomes higher.

The distance measuring device which replaced the movable mirror 914 of FIG. 12 with a fixed mirror is conventional and known in the prior art. In this distance measuring device, the diffraction grating comprises just before an interference profile measuring instrument 915. However, in this distance measuring device, long time is needed for arithmetic processing (the Fourier transform) of data in the interference profile measuring instrument 915.

In the distance measuring device 92 shown in FIG. 14, the fixed mirror 924 is not scanned. Thus, a movable scanning mechanism is unnecessary, and maintenance is unnecessary, too.

However, in the distance measuring device 92, the optical frequency comb source 921 is scanned at frequency. Further, the measurement time becomes longer, and high resolution such as the measuring device of FIG. 12 cannot be obtained.

One object of the present invention is to provide an interferometer that a movable scanning mechanism is not necessary and high-resolution measurement is possible.

In the present invention, a light source to generate predetermined band light (including wideband lights such as the white light) is used. In the present invention because arithmetic for Fourier transforms is not performed, the measurement in the short time is possible.

Another object of the present invention is to provide an interferometer suitable for measurement of a one-dimensional coaxial tomography of a depth direction or a two-dimensional coaxial tomography of a depth direction. In the present invention, an optical path length modulator is used. This optical path length modulator generates modulated light which an optical path length changed into depending on the one-dimensional position on a cross section that is perpendicular to the propagation direction. Before or after the optical path length modulator, the spectroscope to generate the optical frequency comb can be provided.

### Means to Solve the Problem

A thing of an interferometer of the present invention assumes (1)-(6) subject matter.

(1)

Interferometer comprises,

a light source generating a wideband light,

a light path length modulator generating a modulated light that optical path length varies depending on a one-dimensional position on beam cross-section which is perpendicular to the propagation direction,

an optical system which emits for a measuring object wideband light generated by the light source and generates the reflected light, and,

a one-dimensional photo detector which receives the modulated light and the reflected light.

(2)

An interferometer according to (1), wherein the optical path length modulator comprises so that reflection distance varies step by step depending on a one-dimensional position on beam cross-section, and the above light path length varies.

(3)

An interferometer according to (2), further comprising,

a spectrum device which receives wideband light and generates an optical frequency comb,

a phase shift mirror which varies the light path length of the optical frequency comb depending on the depth of the step because the surface is constructed like stairs.

As a spectrum device, VIPA (Virtually Imaged Phased Array) or a resonator can be used.

(4)

Interferometer comprises,

a light source generating a wideband light, a light path length modulator generating the modulated light that optical path length varies depending on a one-dimensional position on a beam cross-section which is perpendicular to the propagation direction,

an optical system which emits to a measuring object wideband light generated by the light source and generates the reflected light, and,

a two-dimensional photo detector which receives the modulated light and the reflected light.

(5)

An interferometer according to (4), wherein the optical path length modulator comprises so that reflection distance varies step by step depending on a one-dimensional position on the beam cross-section, and the above light path length varies.

(6)

An interferometer according to (5), further comprising a spectrum device which receives wideband light and generates an optical frequency comb,
a phase shift mirror which varies the light path length of the optical frequency comb depending on the depth of the step because the surface is constructed like stairs.

### Effect of the Invention

In an interferometer of the present invention, a light source to generate predetermined band light (including wideband lights such as the white light) can be used. Also, an interferometer of the present invention can be comprised not to have a movable scanning mechanism. Because operation such as Fourier transforms is not required in the interferometer of the present invention, the measurement of the short time and the high-resolution measurement are enabled.

In the interferometer of the present invention, measurement of coaxial tomography is possible. Also, in the interferometer of the present invention, the measurement of a one-dimensional coaxial tomography of depth direction or a two-dimensional coaxial tomography of depth direction is possible.

In the interferometer of the present invention, predetermined band light (including wideband lights such as white light, the super continuum light) can be separated spatially as optical frequency comb depending on frequency. A phase of the optical frequency comb separated spatially can be shifted, respectively. The long-distance measurement (the measurement when distance to measuring object is long) is thereby enabled. The interference light that is necessary for the measurement can be obtained by using optical frequency comb generated by a spectrum device. An optical path length of the light to transmit through an optical path length modulator may be different from an optical path length of the incident light reflected in measuring object. However, there must be the difference of the optical path length within the coherence length of each mode comprising comb lights.

### BRIEF DESCRIPTION OF DRAWINGS

FIG. 1 is an explanatory drawing of first embodiment. The embodiment explains an interferometer (a Mach-Zehnder type) of the present invention having VIPA built-in to an optical path length modulator. By this interferometer, a distance to a surface point and a one-dimensional coaxial tomography of depth direction can be measured.

FIG. 2 (A) is a figure showing an optical path length modulator used in an interferometer of FIG. 1, and FIG. 2 (B) is a figure showing an example of a phase shift mirror.

FIG. 3 is explanatory drawing of second embodiment. The embodiment explains an interferometer (a Mach-Zehnder type) of the present invention having VIPA built-in to an optical path length modulator. By this interferometer, distance to points on a surface line and a two-dimensional coaxial tomography of depth direction can be measured (distances in depth direction can be measured with plane (with a two-dimension)).

FIG. 4 is a figure which shows an optical path length modulator used in an interferometer of FIG. 3.

FIG. 5 is an illustration of third embodiment. The embodiment explains an interferometer (a Mach-Zehnder type) of the present invention to measure distance to a surface point and a one-dimensional coaxial tomography of a depth direction without using VIPA.

FIG. 6 is a figure which shows an optical path length modulator used in an interferometer of FIG. 5.

FIG. 7 is an illustration of fourth embodiment. The embodiment explains an interferometer (a Mach-Zehnder type) of the present invention to measure distance to points on a surface line and a two-dimensional coaxial tomography of depth direction without using VIPA.

FIG. 8 is an illustration of fifth embodiment. The embodiment explains an interferometer (a Michelson type) of the present invention to measure distance to a surface point and a one-dimensional coaxial tomography of depth direction with VIPA built-in to an optical path length modulator.

FIG. 9 is an illustration of sixth embodiment. The embodiment explains an interferometer (a Michelson type) of the present invention to measure distance to points on a surface line and a two-dimensional coaxial tomography of the depth direction with VIPA built-in to an optical path length modulator.

FIG. 10 is an illustration of seventh embodiment. The embodiment explains an interferometer (a Michelson type) of the present invention to measure distance to a surface point and a one-dimensional coaxial tomography of depth direction without using VIPA.

FIG. 11 is an illustration of eighth embodiment. The embodiment explains an interferometer (a Michelson type) of the present invention to measure distance to the surface point and a one-dimensional coaxial tomography of depth direction without using VIPA.

FIG. 12 is a figure showing distance measuring device of a conventional Michelson type using white light source.

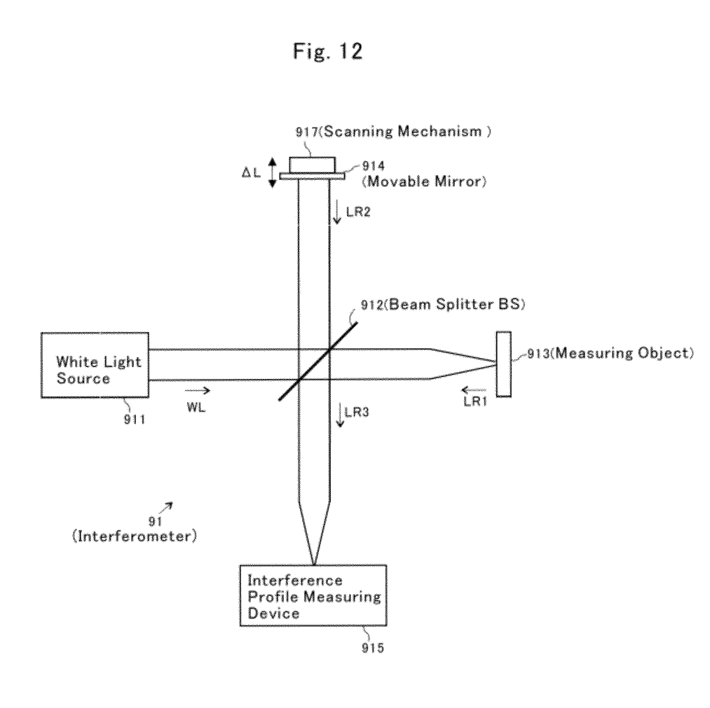

FIG. 13 (A) is a figure showing power spectrum of light source in an interferometer of FIG. 12. FIG. 13 (B) is a figure showing interference wave form.

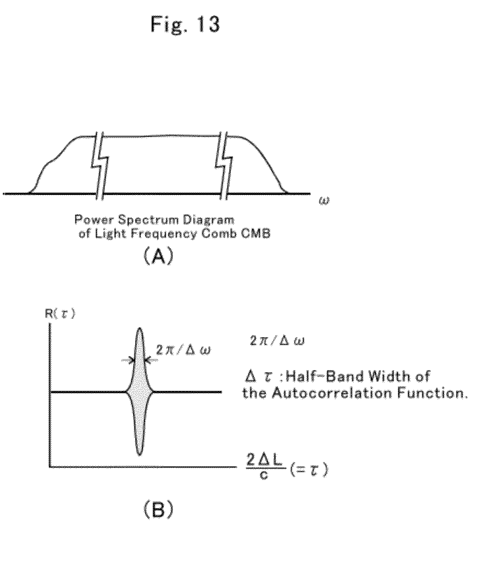

FIG. 14 is a figure which shows distance measuring device using a conventional optical frequency comb source.

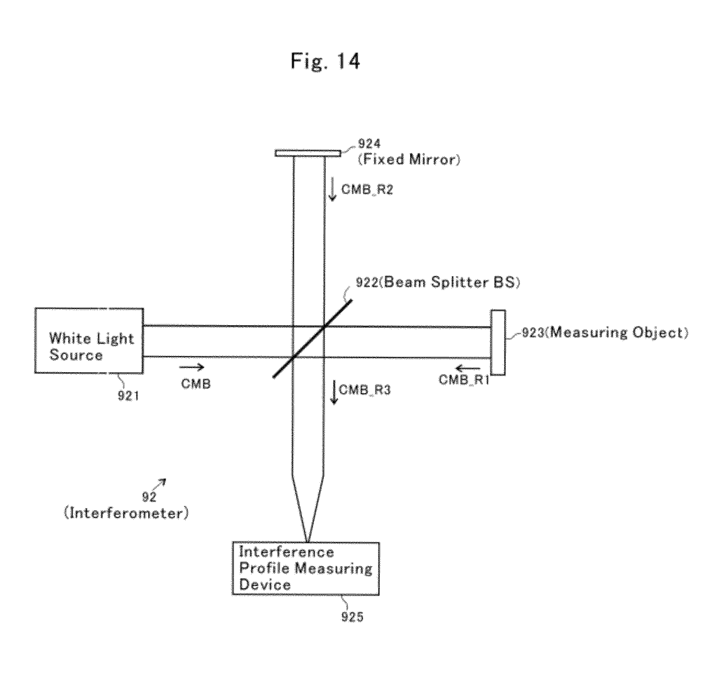

FIG. 15 (A) is a figure showing modes of comb when optical frequency comb is scanned in comb teeth interval. FIG. 15 (B) is a figure showing relationship between width of interference wave form and bandwidth of optical frequency comb.

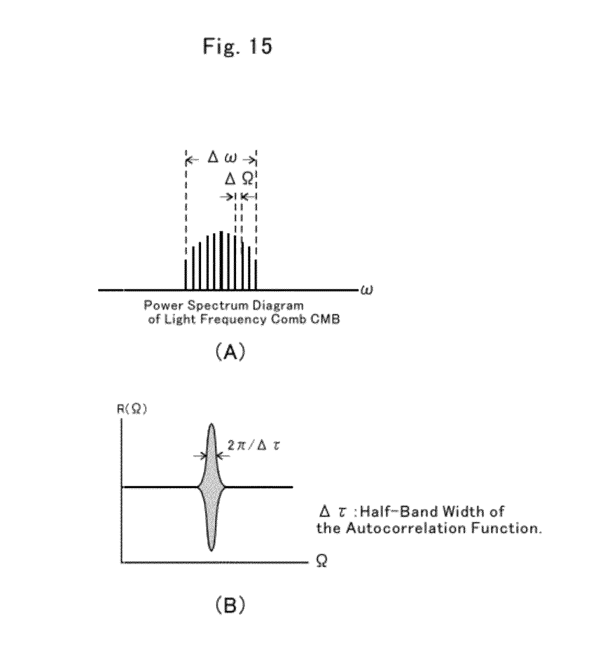

### MODE FOR CARRYING OUT THE INVENTION

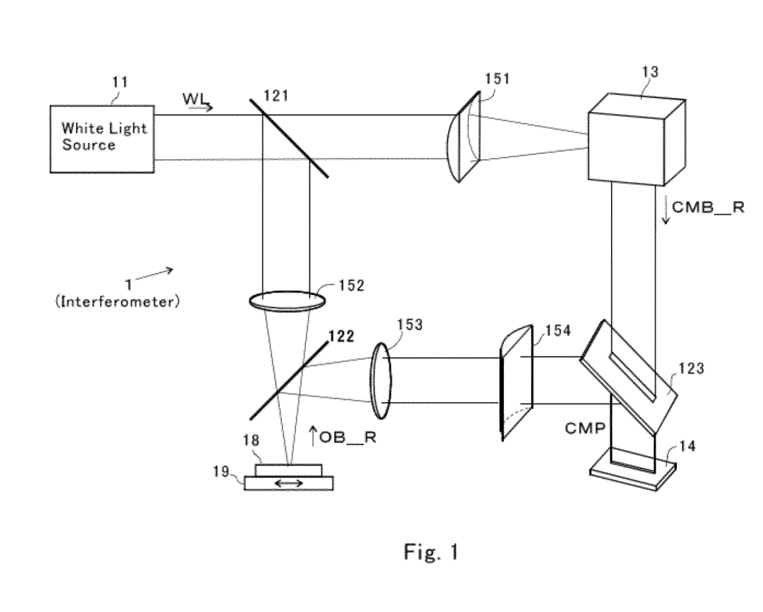

FIG. 1 is an explanatory drawing of first embodiment. The embodiment explains an interferometer of the present invention. A distance from a certain point to a surface point and a one-dimensional coaxial tomography of a depth direction can be measured by using an interferometer (Mach-Zehnder type) of FIG. 1.

An interferometer 1 comprises a white light source 11, beam splitters (BS) 121,122,123, an optical path length modulator 13, an interference profile measuring instrument 14 and lens systems (lens systems are illustrated as lenses 151, 152, 153, 154) in FIG. 1.

For convenience, the lens systems (the lens systems to be described below are included) in the present specification are expressed simply. Thus, the lens system does not need to accord with a lens system in the design.

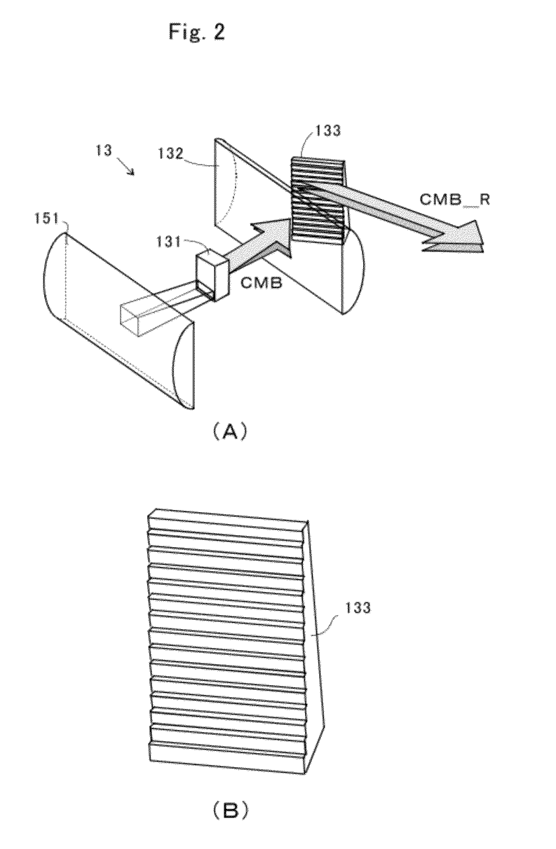

The optical path length modulator 13 comprises a spectrum device 131, a cylindrical lens 132 and a phase shift mirror 133 as shown in FIG. 2 (A).

Wideband light (white light WL) from the white light source 11 is emitted for the optical path length modulator 13 through the beam splitter 121 and the lens system 151 (cylindrical lenses). The optical path length modulator 13 generates the optical frequency comb CMB separated spatially depending on frequency.

The spectrum device 131 is VIPA (Virtually Imaged Phased Array). VIPA can separate spatially teeth (comb teeth) of different frequency.

As shown in FIG. 2 (B) the phase shift mirror 133 is a mirror constructed in a shape of stairs, and phase shift mirror 133 receives comb light CMB. The phase shift mirror 133 reflects comb light CMB. Then the phase shift mirror 133 varies reflection distance in step by step depending on frequency.

In this way, the comb light CMB_R which phase shifted depending on reflection distance is generated. The comb light CMB_R is emitted for the beam splitter 123.

On the other hand, the white light WL from the white light source 11 is emitted for a measuring object 18 through the beam splitter 121, the lens system 152 (cylindrical lenses), and the beam splitter 122. A reflected light (a scattered light) OB_R from the measuring object 18 is emitted for the beam splitter 123 through the beam splitter 122, the lens system 153 (cylindrical lenses) and the lens system 154 (cylindrical lenses).

In FIG. 1, the measuring object 18 is mounted on a moving stage 19.

The measuring object 18 can move with flexibility of one-axis or the flexibility of two-axes horizontally. The beam splitter 123 synthesizes the optical frequency comb (reflected light from the phase shift mirror 133) CMB_R and the reflected light OB_R. The optical frequency comb CMB_R is emitted from the optical path length modulator 13, and the reflected light OB_R is reflected by the measuring object 18. The synthesized light is emitted for the interference profile measuring instrument 14 as synthesized light CMP. The interference profile measuring instrument 14 is a one-dimensional image sensor in the present embodiment. The one-dimensional image sensor receives synthesized light CMP, and the interference profile p (x) is measured.

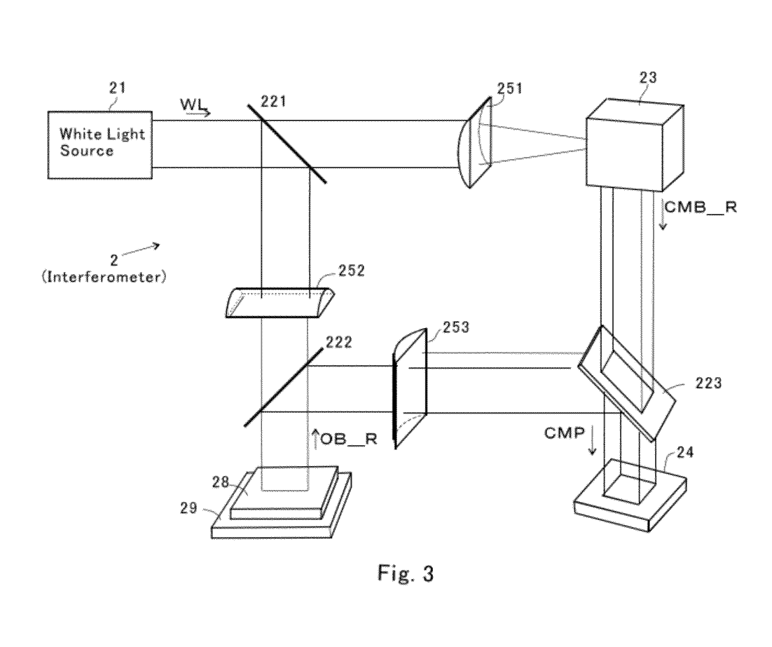

FIG. 3 is an illustration of second embodiment. The embodiment explains an interferometer 2 of the present invention which can measure a two-dimensional distance in the depth direction. In the interferometer (a Mach-Zehnder type) of FIG. 3, a two-dimensional coaxial tomography of the depth direction can be measured.

The interferometer 2 comprises a white light source 21, beam splitters 221,222,223, an optical path length modulator 23, an interference profile measuring instrument 24 and lens systems 251,252,253 in FIG. 3.

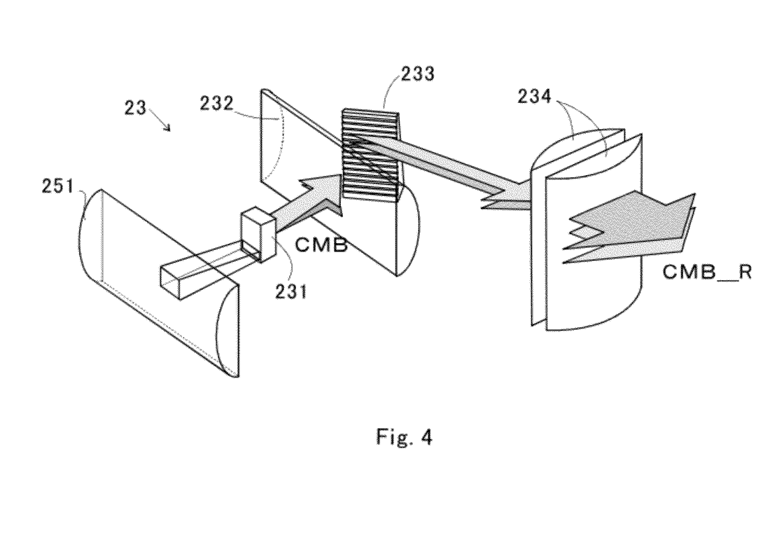

The optical path length modulator 23 comprises a spectrum device 231, a cylindrical lens 232, cylindrical lenses 234,234 and the phase shift mirror 233 as shown in FIG. 4. The optical path length modulator 23 receives white light WL from the white light source 21 through the beam splitter 221 and the lens system (cylindrical lens 251). The optical path length modulator 23 generates the optical frequency comb CMB_R which is separated spatially depending on frequency.

The spectrum device 231 is VIPA the same as the first embodiment. The spectrum device 231 can generate teeth (teeth which comprise modes of CMB) of the different frequency. These teeth (modes of CMB) are separated spatially depending on frequency. The constitution of the phase shift mirror 233 is the same as a constitution of the phase shift mirror 133 in the first embodiment.

The phase shift mirror 233 receives the teeth (modes of CMB), and the phase shift mirror 233 reflects the teeth. A reflection distance of the teeth (modes of CMB) varies depending on frequency step by step. Thereby the optical frequency comb CMB_R which phase shifted depending on the reflection distance is generated. This optical frequency comb CMB_R is expanded in a two-dimensional optical frequency comb by the phase shift mirror 233, and the two-dimensional light frequency comb is emitted for the beam splitter 223.

On the other hand, white light WL from the white light source 21 is emitted for a measuring object 28 through the beam splitter 221, the lens system 252 (cylindrical lens) and the beam splitter 222. The reflected light (a scattered light) OB_R from the measuring object 28 is emitted for the beam splitter 223 through the beam splitter 222 and the lens system 253 (cylindrical lens).

In FIG. 3, the measuring object 28 is mounted on a moving stage 29, and it can bi-axially move horizontally. The beam splitter 223 synthesizes reflected light OB_R from the optical path length modulator 23 and optical frequency comb CMB_R from the measuring object 28, and the beam splitter 223 emits these to the interference profile measuring instrument 24 as synthesized light CMP. The interference profile measuring instrument 24 is a two-dimensional image sensor in the present embodiment. The interference profile measuring instrument 24 receives synthesized light CMP, and the interference profile p (x) is measured.

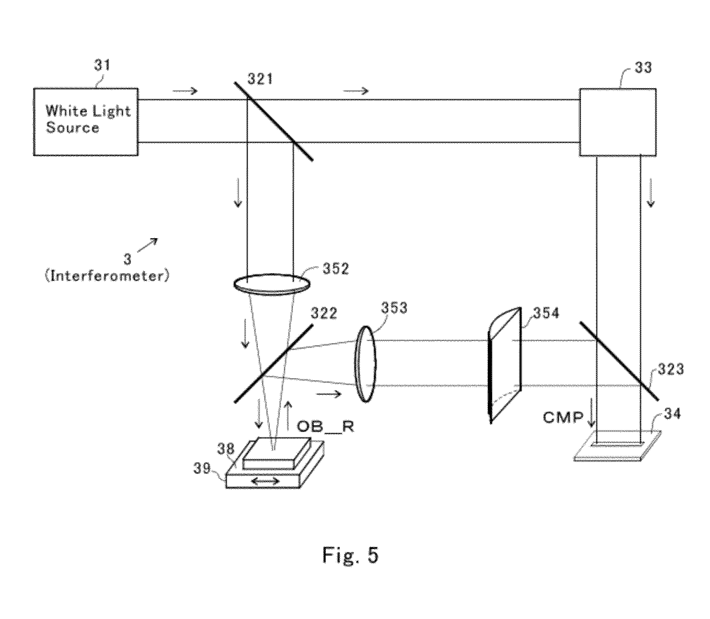

FIG. 5 is explanatory drawing of third embodiment of an interferometer of the present invention. An optical path length modulator 13 having a spectrum device was used in the interferometer (Mach-Zehnder type) of FIG. 1. However, as for the optical path length modulator 33, a spectrum device is not used in the present embodiment. The interferometer of FIG. 5 can acquire space information (a one-dimensional distance to a surface point or a one-dimensional coaxial tomography of the depth direction) of the measuring object 28 the same as the interferometer 1 of the first embodiment. The interferometer of FIG. 5 can acquire properties (energy structural information, index of refraction, transmissivity or reflectivity) of a measuring object 38 in each depth.

An interferometer 3 includes a white light source 31, beam splitters 321,322,323, an optical path length modulator 33, a photo-detector 34 and lens systems 352,353,354 in FIG. 5.

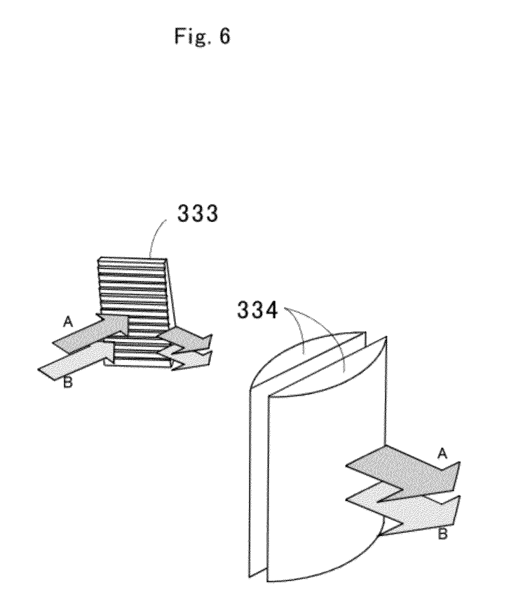

The optical path length modulator 33 comprises a modulation mirror 333 and two cylindrical lenses 334, 334 as shown in FIG. 6. The optical path length modulator 33 receives wideband light (white light) from the white light source 31 through the beam splitter 321, and the wideband light is phase-modulated by the modulation mirror 333 (compare FIG. 6).

The modulation mirror 333 is the mirror which the stairs were formed (the same as a mirror used in the first embodiment or the second embodiment). The modulation mirror 333 receives white light WL. The modulation mirror 333 can reflect back the light WL that reflection distance changed step by step. The optical path length of white light WL varies as indicated in FIG. 6 A, B.

On the other hand, white light WL from the white light source 31 is emitted for the measuring object 38 through the beam splitter 321, the lens system 352 (a cylindrical lens) and the beam splitter 322. The reflected light (a scattered light) from the measuring object 38 is emitted for the beam splitter 323 through the beam splitter 322, the lens system 353 (a cylindrical lens) and the lens system 354 (cylindrical lens).

In FIG. 5, the measuring object 38 is mounted on a moving stage 39, the measuring object 38 can move with flexibility of one-axis or flexibility of two-axes horizontally.

The beam splitter 323 synthesizes reflected light of the modulation mirror 333 and the reflected light of the measuring object 38. Synthetic light is emitted for the photo detector 34. The photo detector 34 is a one-dimensional image sensor in this constitution example.

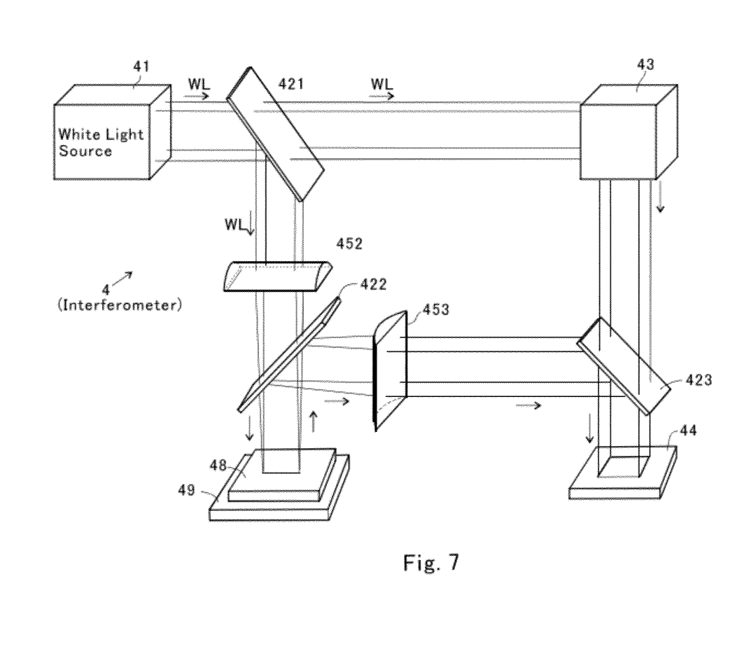

FIG. 7 is explanatory drawing of fourth embodiment of an interferometer of the present invention. In the interferometer (a Mach-Zehnder type) of FIG. 3, the distance to the surface point and the one dimension coaxial tomography of the depth direction are measured using optical path length modulator 23 including the spectrum device. However, in the present embodiment, optical path length modulator 43 does not include a spectrum device.

The interferometer of FIG. 7 can acquire space information (a two-dimensional distance to a surface point and a two-dimensional coaxial tomography of a depth direction) of a measuring object 48 the same as the interferometer 2 of the second embodiment.

An interferometer 4 comprises a white light source 41, beam splitters 421,422,423, an optical path length modulator 43, a photo detector 44 and lens systems 452,453 in FIG. 7. The optical path length modulator 43 is the same as the optical path length modulator 33 shown in FIG. 5.

A constitution of a modulation mirror 433 is the same as the modulation mirror 133 of first embodiment.

White light WL from a white light source 41 is received through the beam splitter 421. The reflection distance of the modulation mirror varies step by step, and white light WL is reflected on the reflection surface. The phase of the white light WL which received is shifted depending on reflection distance thereby.

On the other hand, white light WL from the white light source 41 is emitted for the measuring object 48 through the beam splitter 421, the lens system 452 (cylindrical lens) and the beam splitter 422. The reflected light (a scattered light) of measuring object 48 is reflected by the beam splitter 423 through the beam splitter 422 and lens system 453 (cylindrical lens).

In FIG. 7, the measuring object 48 is mounted on a moving stage 49, and it can bi-axially move horizontally. The beam splitter 423 synthesizes light emitted from the optical path length modulator 43 and light reflected by the measuring object 48 (the reflected light emitted from the beam splitter 423). The synthesized light is emitted for the photo detector 44 which is a two-dimensional image sensor in the present embodiment.

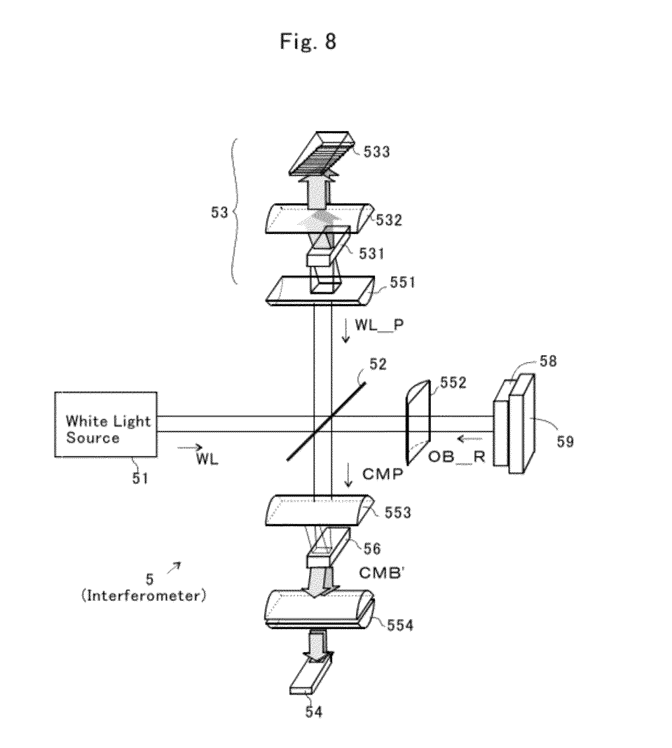

FIG. 8 is explanatory drawing of fifth embodiment of an interferometer of the present invention. By using the interferometer (a Michelson type) of FIG. 8, the distance to the surface point and the one-dimensional coaxial tomography of the depth direction can be measured.

In FIG. 8, an interferometer 5 comprises a white light source 51, a beam splitter 52, an optical path length modulator 53, an interference profile measuring instrument 54 and the lens systems 551,552,553,554. Even the present embodiment can use a light source which can produce wideband light replacing with the white light source 51 the same as the first or the second embodiment. The optical path length modulator 53 comprises the first optical device 531, the cylindrical lens 532 and the phase shift mirror 533. The optical path length modulator 53 receives the white light source 51 from the white light source 51 through the beam splitter 52 and the lens system 551 (cylindrical lens). The optical path length modulator 53 emits the optical frequency comb (CMB_R).

The first optical device 531 is VIPA. The modes of the different frequency are separated spatially, and these can be generated.

The phase shift mirror 533 is a mirror constructed in a shape of stairs. The phase shift mirror 533 receives the optical frequency comb CMB (teeth), and generates the optical frequency comb CMB_R of which the phase is shifted depending on reflection distance. The reflection distance of the phase shift mirror 533 varies depending on frequency of the optical frequency comb CMB (teeth) step by step.

In this embodiment, the phase shift mirror 533 emits reflected light (the optical frequency comb CMB_R) in a reverse path to the first spectrum device 531. The first spectrum device 531 receives the optical frequency comb CMB_R through the phase shift mirror 533. The optical frequency comb CMB_R is changed back to white light WL_P, and it is emitted for into the beam splitter 55.

On the other hand, the white light WL from the white light source 51 is emitted for the beam splitter 52, and it is emitted for a measuring object 58 through the lens system 552 (cylindrical lens). The reflected light OB_R of the measuring object 58 is reflected by the beam splitter 52 through the lens system 552.

The beam splitter 52 synthesizes light (white light WL_P returning with the first spectrum device 531) from the optical path length modulator 53 and the reflected light OB_R from the measuring object 58, and the beam splitter 52 emits synthesized light CMP.

A second spectrum device 56 and a first spectrum device 531 have the same characteristic. The second spectrum device 56 generates the optical frequency comb CMB′ from synthesized light CMP. The interference profile measuring instrument 54 is a two-dimensional image sensor in the present embodiment. The interference profile measuring instrument 54 receives the optical frequency comb CMB', and interference profile p (x) is measured. Note that, in FIG. 8, the measuring object 58 is mounted on a moving stage 59, the measuring object 58 can move on a one-dimensional line or a two-dimensional plane.

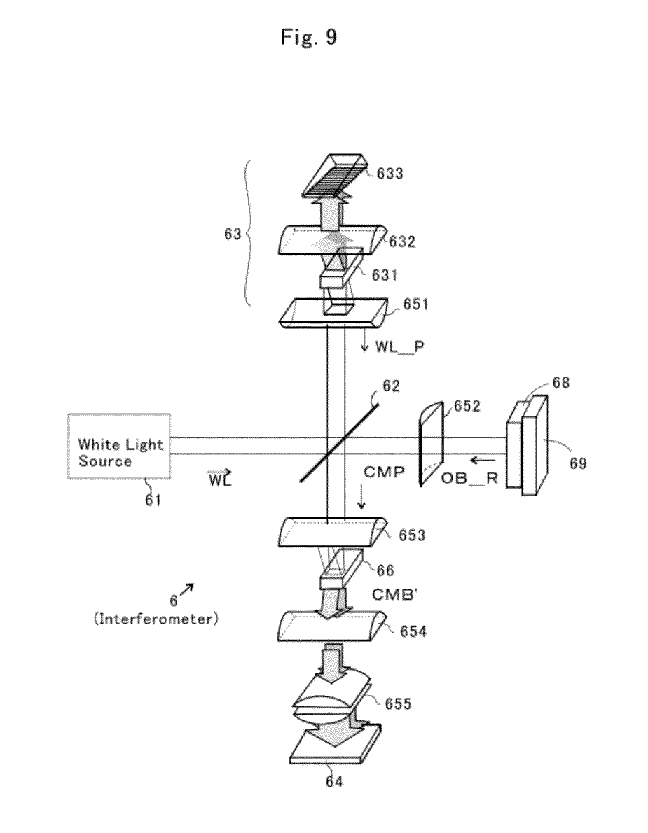

FIG. 9 is explanatory drawing of sixth embodiment. The embodiment explains the interferometers of the present invention. The interferometer of the present invention can perform line measurement (two-dimensional measurement) of distance in the depth direction.

In the interferometer (Michelson type) of FIG. 9, the two-dimensional coaxial tomography of a depth direction can be measured. An interferometer 6 includes a white light source 61, a beam splitter 62, an optical path length modulator 63, an interference profile measuring instrument 64 and lens systems 651,652,653,654,655 in FIG. 9.

In this embodiment, the same as the first embodiment, the second embodiment or the third embodiment, a light source producing a wideband light can be used replacing with the white light source 61. The optical path length modulator 63 receives white light WL from the white light source 61 through the beam splitter 62 and the lens system 651 (cylindrical lens), and emits an optical frequency comb CMB_R. The optical path length modulator 63 comprises a first spectrum device 631, a cylindrical lens 632 and a phase shift mirror 633. The first spectrum device 631 is VIPA, and modes (teeth of comb CMB) of the different frequency separated spatially are generated by spatial separation.

The phase shift mirror 633 is a mirror constructed in a shape of stairs. The phase shift mirror 633 receives the optical frequency comb CMB, and the optical frequency comb CMB is reflected. The reflection distance of the phase shift mirror 633 varies depending on frequency of the optical frequency comb CMB step by step. The optical frequency comb CMB_R of which phase is shifted depending on reflection distance is thereby generated.

In this embodiment, the reflected light of the phase shift mirror 633 is comb light CMB R, the comb light CMBR is emitted for the first spectrum device 631 from the phase shift mirror 633.

The optical frequency comb CMB_R from the phase shift mirror 633 is emitted for the first spectrum device 631. The optical frequency comb CMB_R is changed back into white light, and the white light is entered into the beam splitter 62 as WL_P.

On the other hand, the white light WL from the white light source 61 transmits the beam splitter 62, and it is emitted for the measuring object 68 by the lens system 652 (cylindrical). The reflected light (a scattered light) OB_R of the measuring object 68 is reflected by the beam splitter 62 through the lens system 652.

The beam splitter 62 synthesizes the light from the optical path length modulator 63 and the reflected light OB_R from the measuring object 68. The synthesized light is entered to the second spectrum device 66 through the lens system 653 (cylindrical lens) as the synthesized light CMP.

The second spectrum device 66 has a characteristic the same as the first spectrum device 631. The second spectrum device 66 generates the optical frequency comb CMB′ from the synthesized light CMP. The interference profile measuring instrument 64 is a two-dimensional image sensor in the present embodiment. The interference profile measuring instrument 64 receives the optical frequency comb CMB′ through the lens systems 654, 655 (cylindrical lenses), and interference profile p (x) is measured.

Note that, in FIG. 9, the measuring object 68 is mounted on the moving stage 69. The measuring object 68 can move on a one-dimensional line or a two-dimensional plane.

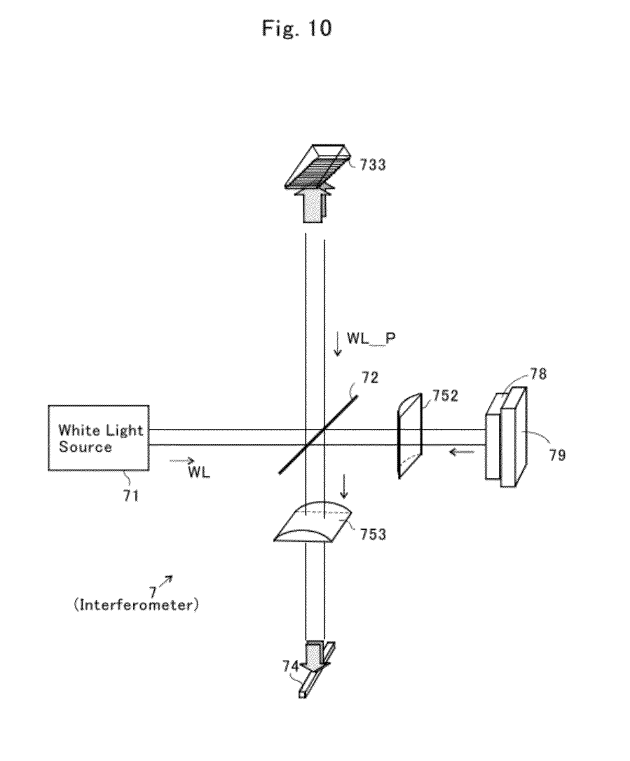

FIG. 10 is an illustration of seventh embodiment of the interferometers of the present invention. In the interferometer (a Michelson type) of FIG. 8, the optical path length modulator 53 having the first spectrum device 531 was used. In this embodiment, any spectrum device is not used for the optical path length modulator 53. The interferometer of FIG. 10 can acquire a distance from the reference point to the surface point or a one-dimensional coaxial tomography of the depth direction about a measuring object 78 the same as the interferometer 5 of the fifth embodiment. The interferometer of FIG. 10 can acquire property (energy structural information, index of refraction, transmissivity, reflectivity) of the measuring object 78 in each depth.

An interferometer 7 includes a white light source 71, a beam splitter 72, the modulation mirror 733 and lens systems 752, 753 in FIG. 10. The modulation mirror 733 receives white light from the white light source 71 through the beam splitter 72, and the modulation mirror 733 emits the white light.

The modulation mirror 733 is a mirror constructed in a shape of stairs. The modulation mirror 733 receives white light, and reflects the white light which reflection distance varies step by step. In this example, the modulation mirror 733 is placed so that reflected light emits in a reverse path. The light from the modulation mirror 733 is emitted for the beam splitter 75.

On the other hand, the white light from the white light source 71 transmits the beam splitter 72, and the white light is emitted for measuring object 78 through a lens system 752 (cylindrical). The reflected light from the measuring object 78 is emitted for the beam splitter 72.

The beam splitter 72 synthesizes the light from the modulation mirror 733 and the reflected light from measuring object 78, and emits the synthesized light.

The photo detector 74 is the two-dimensional image sensor in the present embodiment. Note that, in FIG. 10, the measuring object 78 is placed to a moving stage 79, and the measuring object 78 can move on a one-dimensional line or a two-dimensional plane.

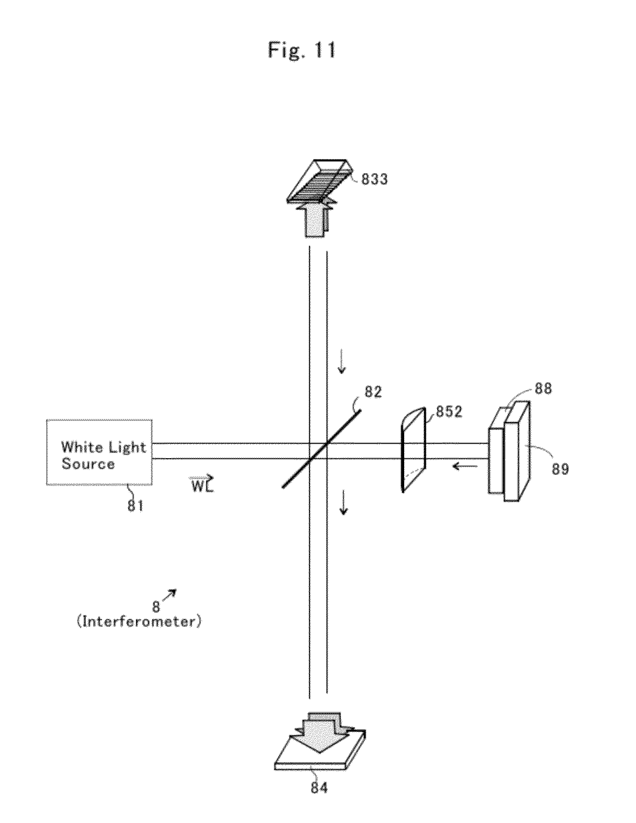

FIG. 11 is an explanatory drawing of the eighth embodiment of the interferometers of the present invention. In the interferometer (Michelson type) of FIG. 9, the distance to the surface point and the two-dimensional coaxial tomography of the depth direction were measured using the light path length modulator 63 with the spectrum device 631. In this embodiment, a spectrum device is not used as the optical path length modulator 63. The interferometer of FIG. 11 can measure a distance to a surface point of a measuring object 89 or a one-dimensional coaxial tomography of the depth direction the same as the interferometer 6 of the sixth embodiment. Also, the interferometer of FIG. 11 can acquire properties (energy structural information, index of refraction, transmissivity, reflectivity) of the measuring object 89 in each depth.

In FIG. 11, the interferometer 8 includes a white light source 81, a beam splitter 82, a modulation mirror 833, a photo detector 84 and a lens system 852.

The modulation mirror 833 receives through the beam splitter 82 in white light from the white light source 81. The modulation mirror 833 emits light shifted at time.

The modulation mirror 833 is a mirror constructed in the shape of stairs. This modulation mirror 833 can generate the light that shifted depending on reflection distance at time. In this embodiment, the modulation mirror 833 is placed to emit in a reverse path. The reflected light from the modulation mirror 833 is emitted for the beam splitter 42.

On the other hand, the white light from white light source 81 transmits beam splitter 82, and it is entered into the measuring object O through the lens system 852 (cylindrical). The reflected light (a scattered light) of measuring object O is reflected by the beam splitter 82 through lens system 852.

The beam splitter 82 synthesizes the reflected light from the modulation mirror 833 and the reflected light from the measuring object O. The synthesized light is entered into the photo detector 84 through the lens system 853 (cylindrical lens).

Photo detector 84 is a two-dimensional image sensor in the present embodiment.

Note that, in FIG. 11, the measuring object 88 is placed to moving stage 89. The measuring object 88 can move on a one-dimensional line or a two-dimensional plane.

### DENOTATION OF REFERENCE NUMERALS

1, 2, 3, 4 interferometer
11, 21, 31, 41 white light source
13, 23, 33, 43 optical path length modulator
14, 24, 34, 44 interference profile measuring instrument
18, 28, 38, 48 measuring object
19, 29, 39, 49 moving stage
32, 35, 42, 121, 122, 123, 221, 222, 223 beam splitter
151, 152, 153, 154, 251, 252, 253, 351, 352, 353, 451, 452, 453, 454 lens system
131, 231 minutes optical device
132, 232, 234, 332, 432 cylindrical lens
133, 233, 333, 433 phase shift mirror
331, 431 first spectrum device

1. Interferometer comprises,
a light source generating a wideband light,
a light path length modulator generating a modulated light that optical path length varies depending on a one-dimensional position on beam cross-section which is perpendicular to the propagation direction,
an optical system which emits for a measuring object wideband light generated by the light source and generates the reflected light, and,
a one-dimensional photo detector which receives the modulated light and the reflected light, and detects at the same time so that a plurality of points of the depth direction for the measurement correspond to the one-dimensional position.

2. An interferometer according to claim 1, wherein the optical path length modulator comprises so that reflection distance varies step by step depending on a one-dimensional position on the beam cross-section, and the above light path length varies.

3. An interferometer according to claim 2, further comprising,
a spectrum device which receive wideband light and generates an optical frequency comb,
a phase shift mirror which varies the light path length of the optical frequency comb depending on the depth of the step because the surface is constructed like stairs.

4. Interferometer comprises,
a light source generating a wideband light,
a light path length modulator generating the modulated light that optical path length varies depending on a one-dimensional position on a beam cross-section which is perpendicular to the propagation direction,
an optical system which emits to a measuring object wideband light generated by the light source and generates the reflected light, and,
a two-dimensional photo detector which receives the modulated light and the reflected light, and detects at the same time so that a plurality of points of the depth direction for the measurement correspond to the one-dimensional position.

5. An interferometer according to claim 4, wherein the optical path length modulator comprises so that reflection distance varies step by step depending on a one-dimensional position on the beam cross-section, and the above light path length varies.

6. An interferometer according to claim 5, further comprising a spectrum device which receive wideband light and generates an optical frequency comb,
a phase shift mirror which varies the light path length of the optical frequency comb depending on the depth of the step because the surface is constructed like stairs.
